(19) United States
(12) Patent Application Publication
(10) Pub. No.: US 2026/0208220 A1
(43) Pub. Date: Jul. 23, 2026

(54) DECK JET WITH INTEGRATED LIGHTING

(71) Applicant: BELLSON ELECTRIC PTY LTD, Caringbah NSW (AU)

(72) Inventor: David John Sanson, Taren Point NSW (AU)

(21) Appl. No.: 19/566,912

(22) Filed: Mar. 13, 2026

Related U.S. Application Data
(63) Continuation-in-part of application No. 19/300,187, filed on Aug. 14, 2025.
(60) Provisional application No. 63/682,966, filed on Aug. 14, 2024.

(51) Int. Cl. B05B 17/08; B05B 1/34; F21S 8/00; F21W 121/02; F21W 131/401

(52) U.S. Cl. CPC B05B 17/08; B05B 1/3402; F21S 8/00; F21W 2121/02; F21W 2131/401

(57) ABSTRACT

An illuminated deck jet apparatus and system has a jet nozzle configured to receive a quantity of water from an inlet pipe and emit a stream of water. A lighting device is positioned substantially directly below the jet nozzle and the stream of water. The lighting device is positioned to emit a quantity of light to illuminate the stream water through the jet nozzle.

### CROSS REFERENCE TO RELATED APPLICATION

This application is a continuation-in-part application of U.S. Patent Application Serial No. 19/300,187 entitled, “Deck Jet Assembly with Integrated Lighting” filed on Aug. 14, 2025, which itself claims benefit of U.S. Provisional Application Serial No. 63/682,966 entitled, “Deck Jet Assembly with Integrated Lighting” filed Aug. 14, 2024, the entire disclosures of which is incorporated herein by reference.

### FIELD OF THE DISCLOSURE

The present disclosure is generally related to illuminated water features and more particularly is related to deck jet assemblies with integrated lighting.

### BACKGROUND OF THE DISCLOSURE

Water features are commonly used to both enhance the appearance of a pool, spa, or similar environment, as well as to make a pool experience more enjoyable for children and adults alike. Similarly, pool related lighting features may add extra ambiance and style. Some pool features have both a water feature component and a lighting feature component, creating a two in one system where the combination of the water feature with lighting provides enhanced aesthetics. Some examples include fountains with a lighting device positioned near the base and angled to shine light on water spraying into the air. However, in this case, there remains a portion of the water that remains unlit from the lighting device, and furthermore, the illumination of the water feature is dependent on ideal weather conditions and pre-positioning the angle of the lighting device relative to the fountain. Conventionally, lighting features and water features, although marketed as together, are two separate systems that are configured to function together.

### SUMMARY OF THE DISCLOSURE

Embodiments of the present disclosure provide an illuminated deck jet apparatus. Briefly described, in architecture, one embodiment of the system, among others, can be implemented as follows. The illuminated deck jet apparatus has a jet nozzle configured to receive a quantity of water from an inlet pipe and emit a stream of water. A lighting device is positioned substantially directly below the jet nozzle and the stream of water, wherein the lighting device is positioned to emit a quantity of light to illuminate the stream water through the jet nozzle.

The present disclosure can also be viewed as providing a deck jet apparatus. Briefly described, in architecture, one embodiment of the apparatus, among others, can be implemented as follows. A deck jet apparatus has a housing having a water inlet. At least one laminar flow filter is positioned in the housing and in a path of a flow of water. A jet nozzle is configured to receive the flow of water and emit a stream of water above the housing. A lighting device is positioned substantially directly below the jet nozzle and the stream of water, wherein the lighting device is positioned to emit a quantity of light to illuminate the stream water through the jet nozzle.

The present disclosure can also be viewed as providing a pool deck jet system. Briefly described, in architecture, one embodiment of the system, among others, can be implemented as follows. A pool deck jet system has a housing positioned within a decking area of a pool, the housing having a water inlet connected to at least one water supply. At least one laminar flow filter is positioned in the housing and in a path of a flow of water. A jet nozzle is configured to receive the flow of water and emit a stream of water above the decking area of the pool. A lighting device is positioned substantially directly below the jet nozzle and the stream of water, wherein the lighting device is positioned to emit a quantity of light to illuminate the stream water through the jet nozzle and above the decking area of the pool.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an isometric view illustration of a first example of deck jet apparatus, in accordance with the present disclosure.

FIG. 2 is a cross-sectional view illustration of the first example of the deck jet apparatus of FIG. 1 in an activated state, in accordance with the present disclosure.

FIG. 3 is a cross-sectional view illustration of the first example of the deck jet apparatus of FIG. 1 in a non-activated state, in accordance with the present disclosure.

FIG. 4 is a detailed isometric view illustration of a filter used with the deck jet apparatus of FIGS. 1-3, in accordance with the present disclosure.

FIG. 5 is an isometric view illustration of the first example of the deck jet apparatus in the activated state of FIG. 2, in accordance with the present disclosure.

FIG. 6 is a front view illustration of a second example of a deck jet apparatus, in accordance with the present disclosure.

FIG. 7 is a side view illustration of the second example of a deck jet apparatus of FIG. 6, in accordance with the present disclosure.

FIG. 8 is a cross-sectional view illustration of the second example of the deck jet apparatus of FIGS. 6-7, in accordance with the present disclosure.

FIGS. 9A-9C are exploded isometric view illustrations of the second example of the deck jet apparatus of FIGS. 6-8, in accordance with the present disclosure.

### DETAILED DESCRIPTION

Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Deck jets are an example of a water feature used to inject water into pools, such as home swimming pools. Deck jets may emit an arcing fountain of water into a pool.

A laminar flow is made by directing a fluid to move along a substantially parallel path. Water is normally supplied with a mostly turbulent flow profile rather than a laminar flow. Usually, large pressure vessels are required to change a fluid from a turbulent flow profile into a laminar flow. A laminar flow of a fluid, like water, in air may function to direct light within the laminar flow. The light within the flow may be partially or totally internally reflected and refracted within the laminar flow, so a person observing the laminar flow might see the flow as clear (little or no light escaping the flow) or glowing with the partially internally reflected and refracted light. A bended path rather than a linear path may enhance the partial internal reflection and refraction of the light within a laminar flow. A laminar flow can “trap” or direct light so that all of the path of the laminar flow is lit until the laminar flow is disrupted. This is in contrast to lighting a laminar flow from outside the laminar flow, where only a portion of the path of the flow might be illuminated and much of the light not directed to the path of the laminar flow. When the laminar flow is broken or disrupted into a turbulent flow, such as when a laminar flow meets a surface like the top of the water in a pool, the laminar flow may release the light, creating an aesthetic pattern or appearance.

When light is directed within a laminar flow, the lighting of the laminar flow is not dependent on ideal weather conditions which would interfere with the impingement of an external light on the laminar flow. Weather conditions may interfere with the path of the light directly, like fog scattering the light before it reaches the laminar flow, or with the position of the laminar flow, like wind changing the location of the laminar flow, which may move the laminar flow out of the light path. A lighting device positioned within the laminar flow may also light the entire laminar flow while the lighting device itself remains stationary. The lighting of the laminar flow is also not dependent on pre-positioning the angle of the lighting device relative to the water feature because a quantity of light from within the laminar flow rather than external to the flow serves to light or trace the path of the laminar flow. One way of creating a lighted laminar flow is to position the lighting device within the water feature itself, so that the water feature and lighting of the water feature may be marketed and sold together rather than as a separate water feature and lighting device.

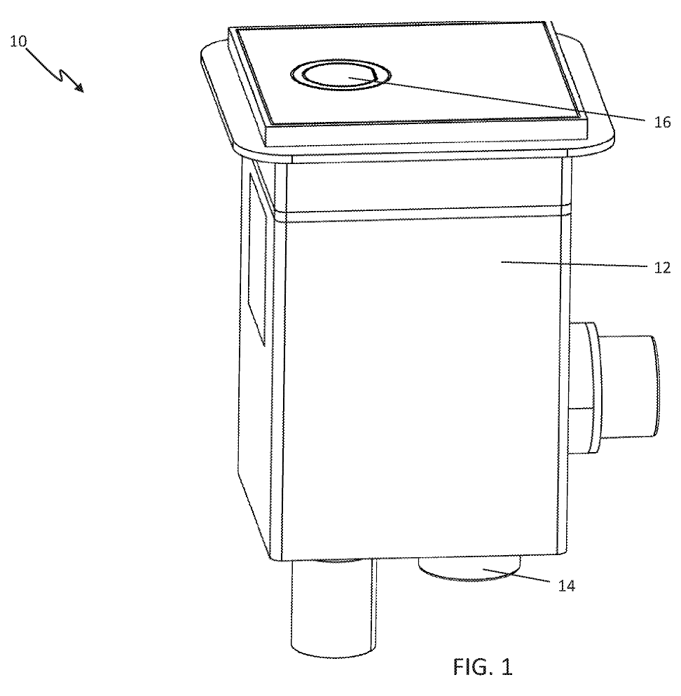

FIG. 1 is an isometric view illustration of a first example of a deck jet apparatus 10, in accordance with the present disclosure. The deck jet apparatus 10 may have a housing 12, and the internal components of the deck jet apparatus 10 may be contained within or interface with the housing 12. Certain elements of the deck jet apparatus 10 may extend beyond the housing 12 or may otherwise be configured to extend out from the housing 12. For example, the deck jet apparatus 10 may have an inlet pipe 14 interfacing with and extending out from a side of the housing 12. The inlet pipe 14 may be configured to receive water from a water source. A pop-up nozzle 16 may be positioned on and interface with a side of the housing 12, such as the top side, and may be fluidically connected to the inlet pipe 14 via a fluid connection within the housing 12. As such, the pop-up nozzle 16 may be configured to receive a quantity of water from an inlet pipe 14, and water entering 40 the deck jet apparatus 10 from the inlet pipe 14 may exit the deck jet apparatus 10 through the pop-up nozzle 16. Pop-up nozzle 16 may have a retracted state and a deployed state. In a retracted state, the pop-up nozzle 16 may sit substantially flush or level with an exterior surface of the housing 12, such as the top surface thereof, or an upper surface of a pool deck when the deck jet apparatus 10 is not in use or when a quantity of water is not present. When water enters the inlet pipe 14 at a sufficient pressure, the pop-up nozzle 16 may extend into the deployed state a predetermined distance, such that at least a portion of the pop-up nozzle 16 extends beyond an exterior surface of the housing 12, and thus allows water to exit the deck jet apparatus 10.

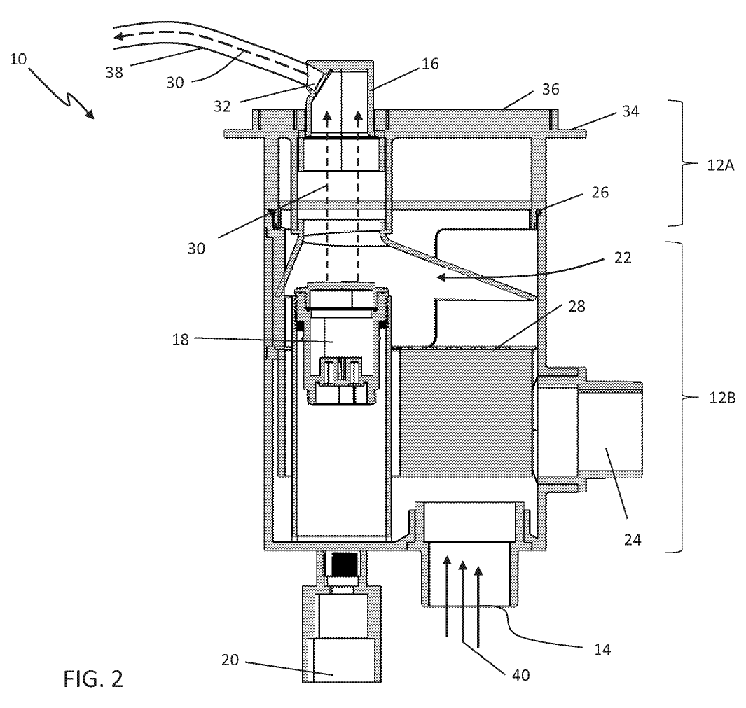

FIG. 2 is a cross-sectional view illustration of the example of the deck jet apparatus 10 of FIG. 1 in an activated state, in accordance with the present disclosure. In particular, FIG. 2 illustrates internal components of the deck jet apparatus 10 with a pop-up nozzle 16 in the extended position. Within the housing 12, represented in FIG. 2 as 12A and 12B, which together may form housing 12, a lighting device 18 may be positioned substantially directly below the pop-up nozzle 16. The lighting device 18 may interface with housing 12 directly or through other internal components. The lighting device 18 may be positioned to emit a quantity of light 30 to illuminate a laminar flow 38 through the pop-up nozzle 16 and through a spout 32. In accordance with this disclosure, the lighting device 18 positioned substantially directly below the pop-up nozzle 16 may be understood to mean that the lighting device 18 is positioned such that a quantity of light 30 is able to illuminate the laminar flow 38 through the pop-up nozzle 16 through the spout 32. This may only mean that a certain portion of the quantity light 30 emitted from the lighting device 18 needs to travel through the laminar flow 38 out of the spout 32. For example, as shown in FIG. 2, the lighting device 18 may be positioned directly below a footprint of the pop-up nozzle 16, and the axes of the lighting device 18 and nozzle 16 are concentric. In other examples, the lighting device 18 may be positioned slightly off center from a footprint of the pop-up nozzle 16.

Water entering 40 through the inlet pipe 14 may be from a pipe, hose, or any other water source which can connect to the inlet pipe 14. The water entering 40 may be turbulent in nature and on passing through the inlet pipe 14 and through the housing 12, water exiting may exit from the pop-up nozzle 16 in a laminar flow 38. The deck jet apparatus 10 may convert the flow of the water entering 40 from turbulent at the inlet pipe 14 to laminar flow 38 at or before the spout 32. The positioning of the lighting device 18 may allow for a portion of the quantity of light 30 emitted from the lighting device 18 to trace or track along the laminar flow 38 of the water exiting, and illuminates the laminar flow 38 along at least a portion of a length of the laminar flow 38, which may extend beyond the pop-up nozzle 16. That is, the stream of water exiting pop-up nozzle 16 may appear to be illuminated intrinsically through internal reflection or refraction of the quantity of light 30 within laminar flow 38.

The deck jet apparatus 10 may have additional internal components within the housing 12 to aid with transitioning the turbulent flow of water entering 40 into a laminar flow 38 of water exiting. Additionally, these components may aid in positioning the lighting device 18 substantially under the pop-up nozzle 16. One such component may be a funnel 22 connected to the internal sidewalls of the housing 12. The funnel 22 may direct or otherwise aid in directing the flow of the quantity of water from the inlet pipe 14 into the housing 12 and towards the pop-up nozzle 16. The lighting device 18 may be positioned to connect to the electrical conduit 20 and may be substantially watertight, such that an electrical connection may travel into the electrical conduit 20 and electrically connect with the lighting device 18, without the electrical connection coming into contact with the water in the housing 12. The electrical connection may be any wire of any diameter that is sufficient to create a watertight seal where the electrical connection enters the housing 12. In one example, the electrical conduit 20 may have a port or connector located externally on the housing 12 such that a power source can be removably connected or fastened to the electrical conduit 20. Electrical conduit 20 may be positioned proximate to a central location in the bottom of the housing 12 to optimize the position of the inlet pipe 14 and improve the laminar flow 38 of water. A filter 28 may be positioned within housing 12 between inlet pipe 14 and pop-up nozzle 16.

The lighting device 18 may be any lighting device 18 that may sufficiently illuminate the laminar flow 38 exiting the pop-up nozzle 16. This may include incandescent bulbs, single color LEDs, or multicolored LEDs. In some examples, the lighting device 18 may include additional circuitry to allow for a user to change the colors of the lighting by a remote and/or through a smart device such as a smartphone that may be wirelessly connected to the lighting device 18 through either one of short-range wireless connection or long-range wireless connection. For example, a pulse-width modulation technique may be used to provide color control of the lighting device 18.

The deck jet apparatus 10 may be positionable at least partially below an upper surface of a pool deck, such as, for example, where a top surface of the deck jet apparatus 10 is flush with a top surface of the pool deck. The deck jet apparatus 10 and housing 12 thereof may be watertight so as to avoid any flooding or water damage under the pool deck. To access and service internal components, such as the lighting device 18, within the housing 12, it may be preferred that the housing 12 be constructed in two pieces. In the example where the housing 12 is constructed in two pieces, there may be a gasket 26 between an upper portion of the housing 12A and a lower portion of the housing 12B to create a watertight seal. The upper portion of the housing 12A may be connected to a lower portion of the housing 12B by gasket 26. The upper portion of the housing 12A may contain a rim 34 positionable at least partially below an upper surface of a pool deck. The upper portion of the housing 12A may be separable from the lower portion of the housing 12B along the gasket 26. The gasket 26 may prevent water from leaking outside the deck jet apparatus 10 in amounts that may damage the pool deck.

The upper portion of the housing 12A may have a rim 34 or flange for installation at least partially below an upper surface of the pool deck, depending on the type of pool decking used. The rim 34 may remain stationary to the deck itself, such that the deck jet apparatus 10 cannot be pulled out using direct vertical force, but rather may require the deck jet apparatus 10 to be tilted and shifted for removal. The rim 34 may have holes for receiving various types of fasteners to secure the deck jet apparatus 10 to the pool deck. In some examples, the upper portion 12A of the housing 12 may also be secured under the pool deck using other fastening methods.

The deck jet apparatus 10 may be installed with the decking layer 36 positioned above the upper portion of the housing 12A and substantially level with the upper surface of the remainder of the pool deck. Substantially level may be understood to mean that the decking layer 36 is visibly level with the pool deck, or otherwise aesthetic in appearance, such that it is not apparent that there is a larger structure under the pool deck, or such that the top portion 12A of the deck jet apparatus 10 is otherwise not protruding from the surface of the pool deck. The decking layer 36 may be made of any material, preferably, the material and color thereof matches the material and color of the pool deck. For instance, a travertine pool deck may have a portion of travertine cut to fit as the decking layer 36, such that the decking is consistent in appearance. Deck jet apparatus 10 may be positioned separated from an edge of the pool deck. When the laminar flow 38 extends beyond pop-up nozzle 16, laminar flow 38 may extend beyond the edge of the pool deck and into the surface of a swimming pool or pond, creating a fountain effect of water from the deck jet apparatus 10 into the swimming pool or pond.

In another example in accordance with the present disclosure, a system to light pool water features may include a single water source fluidly connecting a first deck jet apparatus 10 to a second deck jet apparatus 10. Each deck jet apparatus 10 may be fluidly connected in series to the single water source and to the other deck jet assemblies 10 through a connector pipe 24. The connector pipe 24 may connect to the housing 12 and may generally provide an opening 44 into an area inside the housing 12 containing water. The connector pipe 24 may allow a first deck jet apparatus 10 to fluidly connect to a second deck jet apparatus 10. In some examples, an external pipe may fluidly connect to the connector pipe 24 to fluidly connect one or more deck jet assemblies 10 to one another. This may be beneficial in the case of installing two or more deck jet assemblies 10, where each of the two or more deck jet assemblies 10 are spaced at a distance greater than the length of the connector pipe 24. An external pipe may allow for the deck jet apparatus 10 to be spaced as desired by a user based on their specific pool deck and dimensions thereof. Lighting device 18 within the first deck jet apparatus 10 may be independently controllable as described above from lighting device 18 within the second deck jet apparatus 10. For instance, lighting device 18 within the first deck jet apparatus 10 may be independently controllable to turn on or off or to emit a color of the quantity of light 30 that is of a different wavelength than the color of the quantity of light 30 emitted by lighting device 18 within the second deck jet apparatus 10. The first deck jet apparatus 10 and the second deck jet apparatus 10 may also be independently controllable to extend laminar flow 38 beyond the pop-up nozzle 16.

Similarly, the single water source of deck jet apparatus 10 may be fluidly connected in parallel to the first deck jet apparatus 10 and the second deck jet apparatus 10, where, for example, a single water source may fork into multiple pipes and each of the multiple pipes may fluidly connect to the connector pipe 24 of deck jet apparatus 10, which may receive water from the single water source through its inlet pipe 14. This configuration may be beneficial over each deck jet apparatus 10 having its own water source, as it will ensure relative and substantially equal pressures between each deck jet apparatus 10, and thus, ensures that the spouts 32 of each pop-up nozzle 16 are consistent and substantially equal in water pressure.

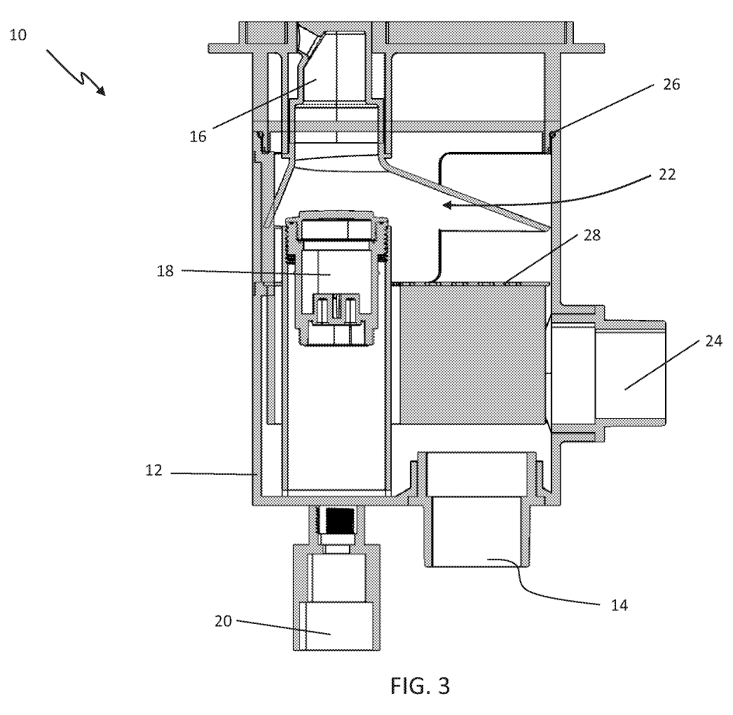

FIG. 3 is a cross-sectional view illustration of the example of the deck jet apparatus 10 of FIG. 1 in a non-activated state, in accordance with the present disclosure. In particular, the deck jet apparatus 10 depicted in FIG. 3 may have a filter 28 positioned within the housing 12 at a position between the inlet pipe 14 and the funnel 22. In some examples, the filter 28 may be positioned within a portion of the funnel 22. The filter 28 may be any filter 28 which is capable of disrupting the turbulent flow of a quantity of water incoming from the inlet pipe 14 and forming laminar flow 38 with the quantity of water, which laminar flow 38 may extend beyond the pop-up nozzle 16. In some examples, the filter 28 may be a plastic woven filter 28. FIG. 3 contains many of the same features, structures, and functions as described relative to FIGS. 1-2, which are not restated for FIG. 3 for brevity in disclosure. Creation of laminar flow 38 with filter 28 may be preferred over use of a pressure vessel to create laminar flow 38 because of the size of the pressure vessel, which may be larger than 6 inches by 6 inches, or a similar compact space. Space within or under a pool deck may be limited due to plumbing beneath the pool deck and structural requirements for the pool deck. In one example, it may be preferred that a length and a width of the housing 12 of the deck jet apparatus 10 does not exceed 6 inches by 6 inches, which may not be possible with a pressure vessel. Limiting the length and the width of the housing 12 may also offer advantages to installation of the deck jet apparatus 10.

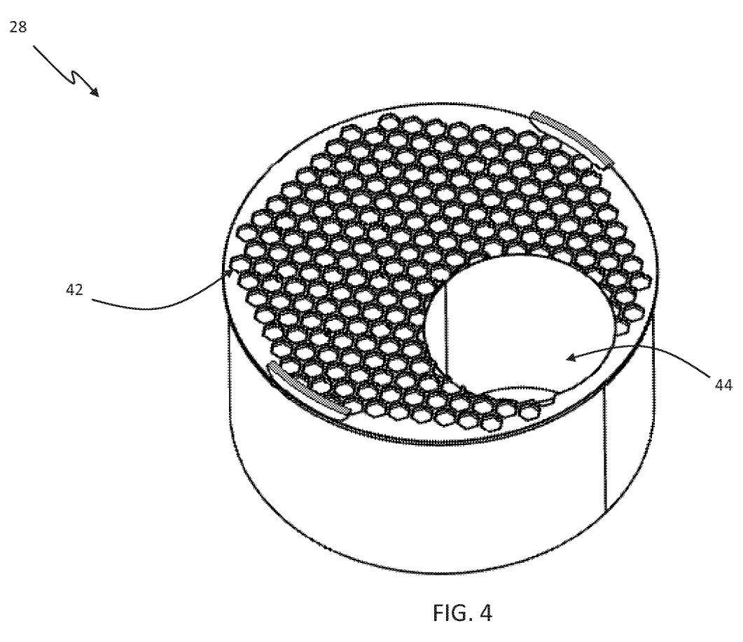

FIG. 4 illustrates a close-up isometric view of the filter 28 used with the deck jet apparatus 10 of FIG. 1, in accordance with the present disclosure. As shown, the filter 28 may be formed from a plurality of pores 42 or apertures. With reference to FIGS. 2-3, the filter 28 may have an opening 44 configured to receive the lighting device 18, or an electrical wire electrically connected to the lighting device 18. The plurality of pores 42 may be formed around the opening 44 and within the bounds of the filter 28. The plurality of pores 42 may extend for the entirety of the height of the filter 28, allowing turbulent water to enter the filter 28 from one end, where the turbulent flow is disrupted, and exit from the other end as a laminar flow 38. The laminar flow 38 of the water may extend beyond the pop-up nozzle 16. Of note, the pores 42 of the filter 28 need not be honeycomb shaped or in a honeycomb configuration. While this configuration may optimize use of surface area and volume of the filter 28 body, the pores 42 may be any shape and in any configuration on the filter 28 body.

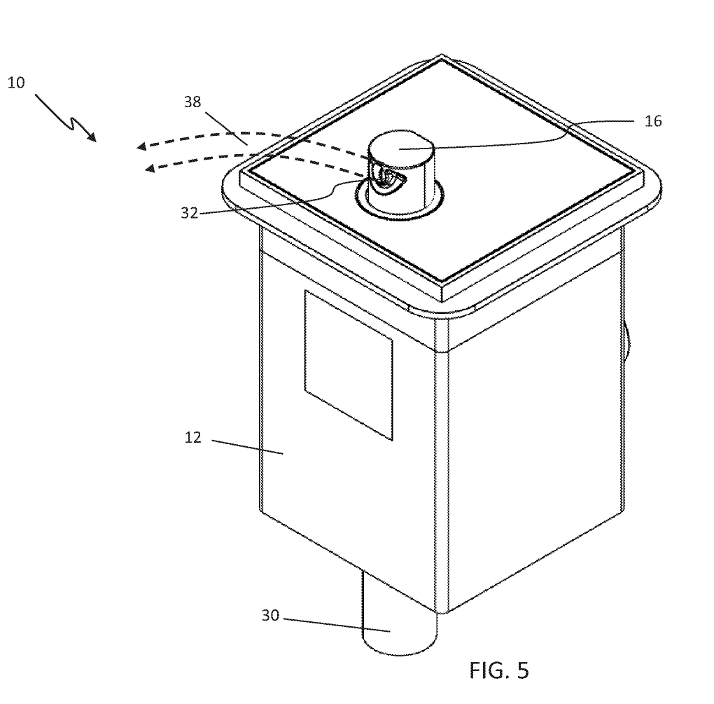

FIG. 5 illustrates an isometric view of the example of the deck jet apparatus 10 of FIG. 2 in the activated state, in accordance with the present disclosure. As shown, the pop-up nozzle 16 is in the extended or active position, where water exiting may exit from the spout 32 of the pop-up nozzle 16 in a laminar flow 38 as previously discussed. FIG. 5 contains many of the same features, structures, and functions as described relative to FIGS. 1-3, which are not restated for FIG. 5 for brevity in disclosure.

With reference to FIGS. 1-5, the deck jet apparatus 10 may be made of any material that is commonly used in association with pools, lighting features, and water features. This includes plastic, stone, concrete, plaster, metal, composite materials, or treated wood. In some cases, the different components of the deck jet apparatus 10 may be made of different materials. For example, most of the housing 12 itself may be of a plastic or metal material, but the portion of the housing 12 having the pop-up nozzle 16, and thus, the portion of the housing 12 visible to a user, may be made of a more aesthetic material or have a vinyl layer attached thereto. Similarly, internal components of the housing 12 such as the inlet pipe 14, pop-up nozzle 16, lighting device 18, electrical conduit 20, funnel 22, connector pipe 24, gasket 26, and filter 28 may be made of a different material than that of the housing 12. Internal components of the deck jet apparatus 10 may preferably be made of a plastic, metal, or composite material, as the case may be for durability, ease of repair, ease of manufacture, and cost efficiencies.

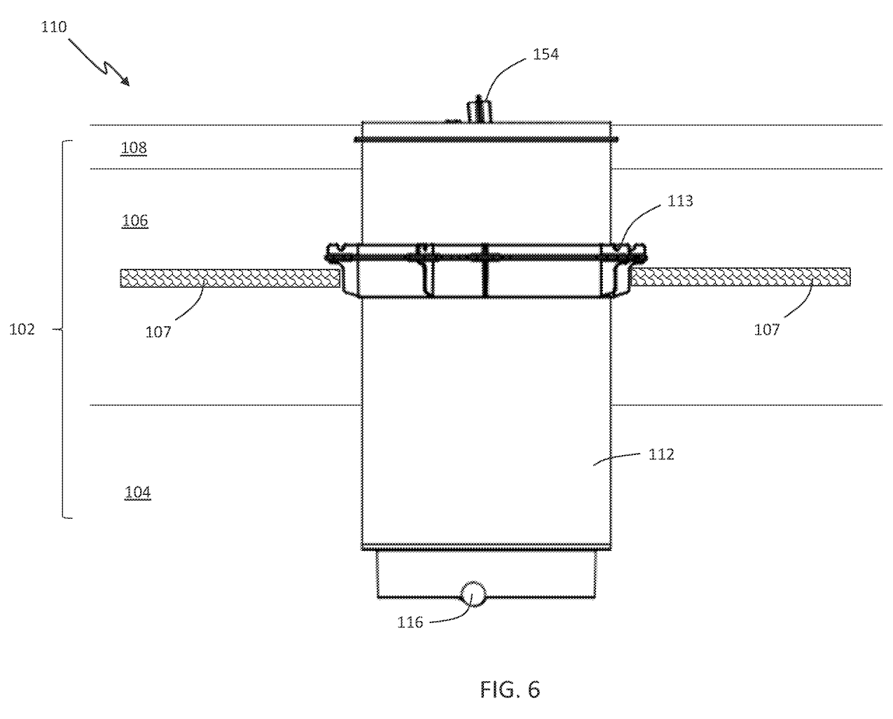

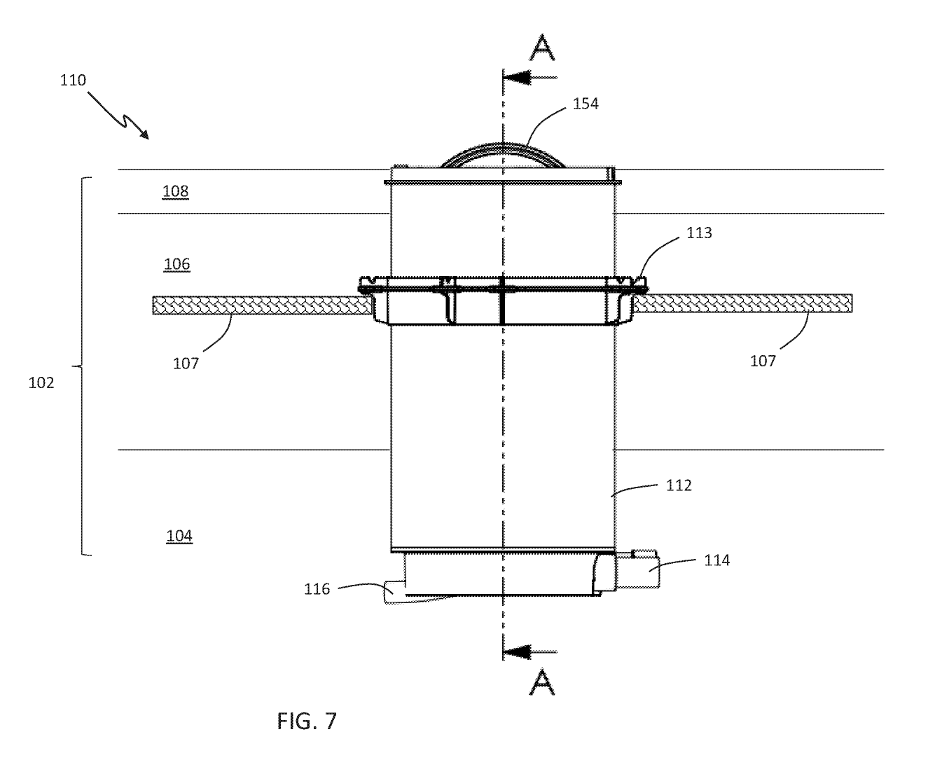

A second example of a deck jet apparatus 110 and system is described relative to FIGS. 6-9C. FIG. 6 is a front view illustration of a second example of a deck jet apparatus 110, in accordance with the present disclosure, and FIG. 7 is a side view illustration of the second example of a deck jet apparatus 110 of FIG. 6, in accordance with the present disclosure. With reference to FIGS. 6-7, the deck jet apparatus 110 includes a housing 112 which is positionable within or partially within a decking area 102, such as pool decking or other areas where the deck jet apparatus 110 is desired to be used. Typically, the decking area 102 may be an area immediately surrounding a pool, a spa, splashpad, or a similar water environment. The decking area 102 may generally be constructed from a concrete material, but other materials may also be used.

As shown in FIGS. 6-7, in this location in the decking area 102, a lower end of the housing 112 may be in the ground 104 (or in a position below the concrete layer 106), a middle section of the housing 112 positioned in the concrete layer 106 or a similar material where it may be secured to rebar 107 or a similar concrete reinforcement material, and the top part of the housing 112 positioned proximate to the upper decking layer 108. In this position, the top part of the housing 112 may be substantially aligned with or flush with the top surface of the upper decking layer 108, such that the deck jet apparatus 110 does not obstruct or interfere with the ability to use the decking area 102, such as by being a tripping hazard.

The upper decking layer 108 may be formed from various materials, including brick, stone, travertine, concrete, composite material, or others. In some situations, the concrete layer 106 and the upper decking layer 108 may be a continuous layer, such as where the concrete layer 106 and the decking layer 108 are integral. In other example, the concrete layer 106 may be positioned as part of the pool structure or shell, such as when the pool is formed from shotcrete or gunite, and the upper edge of that shell extends laterally from the pool. In this case, the housing 112 may be connected to rebar 107 which is interfacing with the pool shell itself.

The housing 112 may generally define the outer containment structure of the deck jet apparatus 110, where it may be formed to generally enclose a majority of components of the deck jet apparatus 110. As such, the housing 112 may separate the components from the concrete 106 or other layers of the decking area 102. On an outside of the housing 112 may be an attachment ring 113, which may be a structure which allows the housing 112 to be secured to the rebar 107, such that the housing 112 may be retained in a substantially stationary position in the decking areas 102 during construction of the decking area 102 and afterwards. For instance, the attachment ring 113 may be positioned around the housing 112 and it may connect to the rebar 107 such that uncured concrete does not dislodge the housing 112 from the desired position when it is poured. The attachment ring 113 may be positionable at various heights of the housing 112, such that the upper part of the housing 112 can be positioned in the desired location relative to the upper decking surface 108.

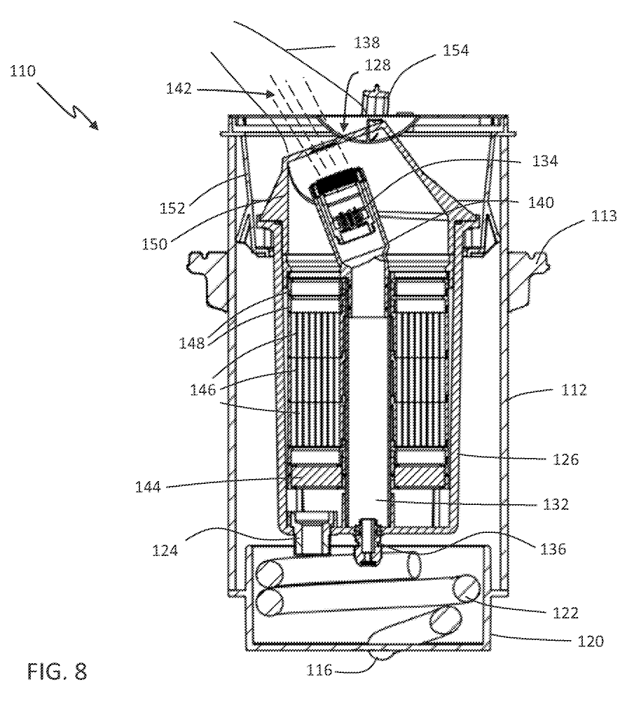

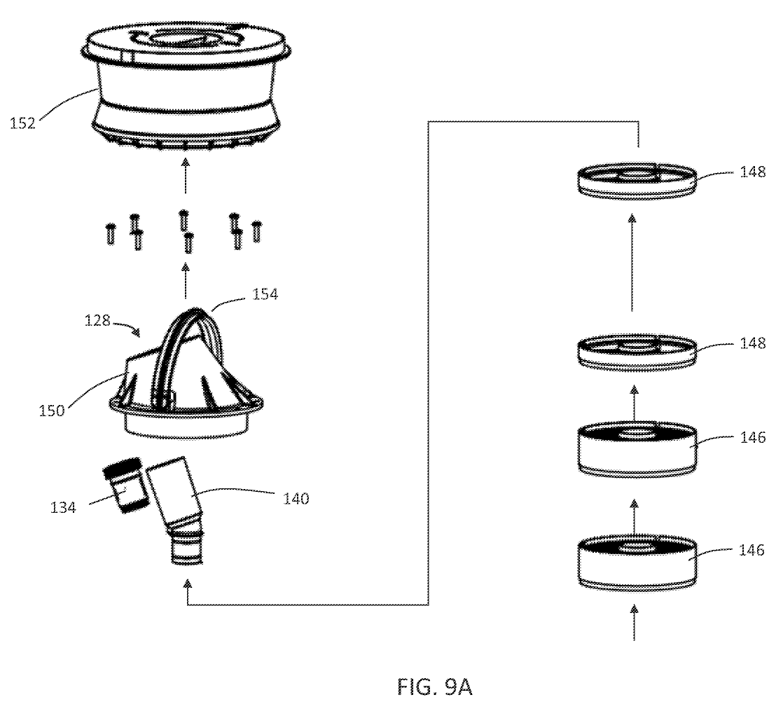

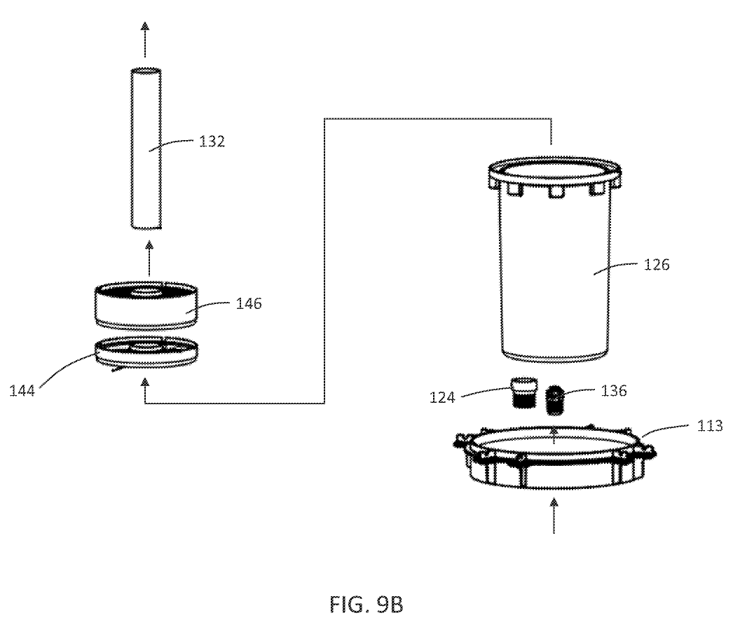

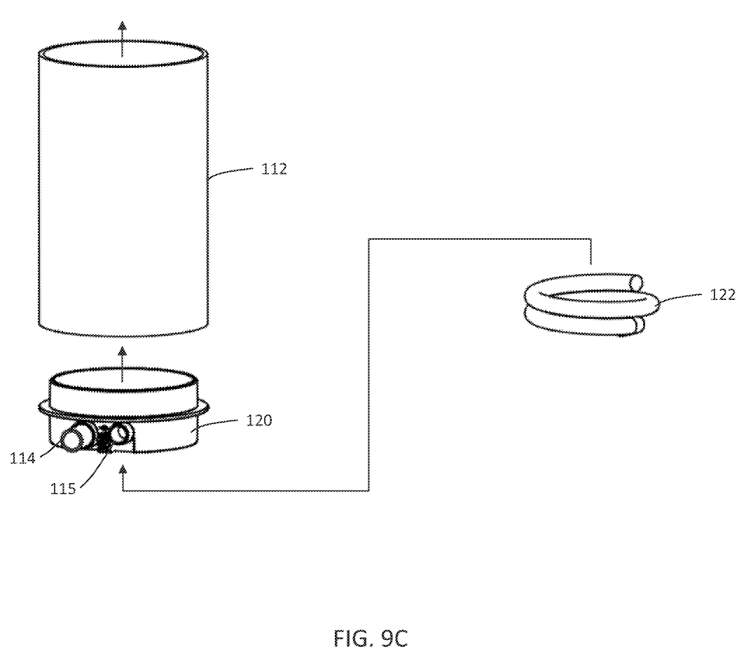

As shown best in FIG. 7, below or at a lower end of the housing 112 is an inlet pipe 114 for providing a supply of water to the deck jet apparatus 110 and an electrical connector 116 which provides an electrical connection for supplying power to the deck jet apparatus 110. The inlet pipe 114 may be connected to a water supply of the pool or another water supply, which is typically in the form of piping within the decking area 102 or below it. For example, the piping may include a network of PVC pipes which transport water from a pool pump to the deck jet apparatus 110. Similarly, the electrical connector 116 may be connected to one or more conduits having an electrical wire which provides power and/or control signals to one or more lights within the deck jet apparatus 110. Additionally, at the top of the housing 112 may be an extended jet handle 154 which is connected to a jet head 150 (FIGS. 8-9C) which emits water from the deck jet apparatus 110, where extended jet handle 154 may allow a user to physically manipulate the deck jet apparatus 110, such as by pointing or angling the jet head 150 to the desired position. These features are described in further detail relative to FIGS. 8-9C.

Turning to FIG. 8, it is a cross-sectional view illustration of the second example of the deck jet apparatus 110 of FIGS. 6-7, in accordance with the present disclosure. In particular, FIG. 8 illustrates the cross-sectional view of the deck jet apparatus 110 depicted in FIG. 7 taken along line A-A in FIG. 7. FIGS. 9A-9C are exploded isometric view illustrations of the second example of the deck jet apparatus 110 of FIGS. 6-8, in accordance with the present disclosure, and FIGS. 9A-9C illustrate each of the components of the deck jet apparatus 110 separately, but in schematic alignment with one another, as indicated by the arrows.

With reference to FIGS. 6-9C together, the housing 112 may be a substantially cylindrical structure which encloses or contains most of the components of the deck jet apparatus 110. As shown, at a bottom end of the housing 112 may be a laminar niche 120 which may separatable from the cylindrical body of housing 112 such that the laminar niche 120 can be connected to the cylindrical body. The laminar niche 120 may have a collar which allows for precision connection to the cylindrical body, whereby an upper edge of the laminar niche 120 can be received within the cylindrical body of the housing 112. In one example, the inlet pipe 114 and the electrical connector 116 may be integrated into the laminar niche 120. As shown in FIG. 9C, it may be possible to include a primary inlet pipe 114 for receiving water, and a secondary pipe 115 for connecting the deck jet apparatus 110 to another apparatus 110, such as for in series connections, as previously discussed.

The electrical connector 116 may be connected to an electrical cable 122 which may be coiled or housed within the laminar niche 120, and which is electrically connected to a lighting device 134 of the deck jet apparatus 110. The electrical cable 122 may facilitate power supply and instructional signal to the lights of the deck jet apparatus 110, and may be coiled to allow removal of the components of the deck jet apparatus 110 without disconnection of the electrical feed. For example, when the light of the deck jet apparatus 110 is removed, or the inner housing 126, the coiled electrical cable 122 may uncoil to allow for service of the deck jet apparatus 110 without disconnection of the electrical cable 122, and then be recoiled into the laminar niche 120 upon reinstallation of the components of the deck jet apparatus 110.

At an upper end of the laminar niche 120 may be a conduit adapter 124 which interconnects the water supply from inlet pipe 114 to the inner housing 126, either directly or indirectly. As shown, the inner housing 126 may be positioned within housing 112 and may receive the inlet feed of water from conduit adapter 124, where the water is moved through various structures and eventually emitted from the jet nozzle 128 of the deck jet apparatus 110.

The inner housing 126 may have a cylindrical shape with a center cavity defined by a hollow shaft 132, whereby the electrical connection to the lighting device 134 is provided through the hollow shaft 132 while the water supply to the jet nozzle 128 is provided radially exterior of the hollow shaft 132. For instance, the electrical connection from electrical connector 116 may feed electrical cable 122, which is connected through an electrical adapter 136 extending to hollow shaft 132, which connects to lighting device 134. The lighting device 134 may be positioned substantially directly below the jet nozzle 128 such that it is capable of emitting light into the laminar flow of the stream of water 138 exiting the jet nozzle 128 to illuminate it. It is noted that the lighting device 134 may include any type of light, but it may commonly be a low voltage light, such as a light-emitting diode (LED) or an array of LEDs, which can illuminate the water stream 138 emitted from jet nozzle 128. The lighting device 134 may be connected to the hollow shaft 132 with a light adapter 140, which may angularly mount the lighting device 134 relative to an elongated axis of the hollow shaft 132, thereby allowing the light path 142 from lighting device 134 to be directed at an angle.

Regarding the water flow, water enters the inner housing 126 from conduit adapter 124 where it is moved various filters which may be shaped to fit within inner housing 126 yet allow for the hollow shaft 132 to extend therethrough. For instance, the water may move through a first filter 144, which may be formed as a honeycomb jet filter, whereby the water is caused to flow through a plurality of parallel channels or paths having a honeycomb cross section. This honeycomb shape of the first filter 144 may help transition the water flow from turbulent to laminar. The water continues to secondary filters 146 which are positioned upstream from first filter 144. The secondary filters 146 may be round-hole filters, which include a plurality of parallel channels or paths having a circular cross-section, which helps to further transition the flow of water to a laminar flow. Any number of additional filters or spacers 148 may be used within inner housing 126, which may be used to further process the water as it moves through the inner housing 126, or to maintain the desired positioning or spacing of the first filter 144 and secondary filters 146.

Near the top of the inner housing 126, the water may enter the jet head 150 which includes an interior space with sidewalls that direct the water from the bottom thereof and towards the jet nozzle 128. The jet head 150 may be connected to the inner housing 126 with fasteners or similar devices, such that the water pressure in the inner housing 126 does not dislodge the jet head 150 from its position. The jet head 150 may have sufficient interior space to accommodate lighting device 134 which generally is positioned towards a center of the jet head 150, but interior of the jet nozzle 128. This may help ensure that the water flow around the lighting device 134 can coalesce before exiting the jet nozzle 128. The jet head 150 may be positioned within the upper housing 152 which may be connected to housing 112, which may assist with connecting the inner housing 126 and jet head 150 to the housing 112. The upper housing 152 may include sidewalls and a ceiling which covers a portion of the housing 112 at the top plane thereof, such that components of the deck jet apparatus 110 can be effectively housed by the upper housing 152, yet the jet stream of water 138 can be emitted.

In use, pressurized water is flowed through first filter 144 and secondary filters 146 to achieve or help achieve a laminar flow of the water. The water moves past lighting device 134 and exits the jet nozzle 128 with sufficient force to propel the water into a constant water stream 138 to an elevated position above the housing 112 and the deck jet apparatus 110, such as into an air space thereabove. The water stream 138 may be any height or size, but is typically less than 1.0 inch in diameter and commonly achieves heights between 1-20 feet. While the water is exiting the jet nozzle 128 and forming the water stream 138, the lighting device 134 is emitting a beam of light along light path 142 which is directed into the water stream 138. The result of the water stream 138 formed from a laminar flow, or substantially a laminar flow, with the light beam along light path 142 allows for the water stream 138 to be illuminated.

It may be possible for a user to manipulate the position of the jet head 150, and thus the direction of the water stream 138 and light path 142 by adjusting a jet handle 154 which is positioned extending from the jet head 150. For instance, the jet handle 154 may allow for rotational movement of the jet head 150.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure.

What is claimed is:

1. An illuminated deck jet apparatus comprising:
a jet nozzle configured to receive a quantity of water from an inlet pipe and emit a stream of water; and
a lighting device positioned substantially directly below the jet nozzle and the stream of water, wherein the lighting device is positioned to emit a quantity of light to illuminate the stream water through the jet nozzle.

2. The illuminated deck jet apparatus of claim 1, wherein the lighting device is positioned interior of a jet head on which the jet nozzle is formed.

3. The illuminated deck apparatus of claim 2, wherein the jet head is connected to an inner housing.

4. The illuminated deck jet apparatus of claim 1, further comprising a housing, wherein the inlet pipe is connected at a bottom end of the housing and the jet nozzle is positioned at a top end of the housing.

5. The illuminated deck jet apparatus of claim 4, further comprising an inner housing positioned within the housing and between the inlet pipe and the jet nozzle, wherein at least one filter is positioned within the inner housing in a path of the quantity of water.

6. The illuminated deck jet apparatus of claim 5, wherein the filter further comprises at least one laminar flow filter, the laminar flow filter being at least one of a honeycomb filter or a round-shape filter.

7. The illuminated deck jet apparatus of claim 5, further comprising a hollow shaft positioned within the inner housing, wherein an electrical connection to the lighting device is positioned at least partially within the hollow shaft.

8. The illuminated deck jet apparatus of claim 4, further comprising a laminar niche connected to a lower end of the housing.

9. The illuminated deck jet apparatus of claim 8, further comprising at least one electrical cable positioned within the laminar niche.

10. A deck jet apparatus comprising:
a housing having a water inlet;
at least one laminar flow filter positioned in the housing and in a path of a flow of water;
a jet nozzle configured to receive the flow of water and emit a stream of water above the housing; and
a lighting device positioned substantially directly below the jet nozzle and the stream of water, wherein the lighting device is positioned to emit a quantity of light to illuminate the stream water through the jet nozzle.

11. The deck jet apparatus of claim 10, wherein the lighting device is positioned interior of a jet head on which the jet nozzle is formed.

12. The deck apparatus of claim 11, wherein the jet head is connected to an inner housing, the inner housing positioned interior of the housing.

13. The deck jet apparatus of claim 12, further comprising a hollow shaft positioned within the inner housing, wherein an electrical connection to the lighting device is positioned at least partially within the hollow shaft.

14. The deck jet apparatus of claim 10, wherein the at least one laminar flow filter comprises at least one of a honeycomb filter or a round-shape filter.

15. The deck jet apparatus of claim 10, further comprising a laminar niche connected to a lower end of the housing.

16. A pool deck jet system comprising:
a housing positioned within a decking area of a pool, the housing having a water inlet connected to at least one water supply;
at least one laminar flow filter positioned in the housing and in a path of a flow of water;
a jet nozzle configured to receive the flow of water and emit a stream of water above the decking area of the pool; and
a lighting device positioned substantially directly below the jet nozzle and the stream of water, wherein the lighting device is positioned to emit a quantity of light to illuminate the stream water through the jet nozzle and above the decking area of the pool.

17. The pool deck jet system of claim 16, further comprising:
an inner housing removably postitionable within an interior of the housing; and
at least one electrical cable positioned in a laminar niche connected to the housing, wherein the inner housing is removable from the interior of the housing without disconnection of the electrical cable to the lighting device.

18. The pool deck jet system of claim 16, further comprising an attachment ring positioned on an exterior of the housing, the attachment ring connected between rebar in concrete of the decking area and the housing.

19. The pool deck jet system of claim 16, wherein the jet nozzle is formed on a jet head, the jet head positioned interior of the housing, wherein the jet head is rotatable to adjust a direction of the stream of water.

20. The pool deck jet system of claim 16, wherein the wherein the at least one laminar flow filter comprises at least one of:
a honeycomb filter having a plurality of parallel paths having a honeycomb cross section; or
a round-shape filter having a plurality of parallel channels having a circular cross-section.
